(19) United States
(12) Patent Application Publication
(10) Pub. No.: US 2016/0163354 A1
(43) Pub. Date: Jun. 9, 2016

(54) Programme Control

(71) Applicant: BRITISH BROADCASTING CORPORATION, London (GB)

(72) Inventors: Jana Eggink, London (GB); Denise Bland, London (GB)

(21) Appl. No.: 14/900,876

(22) PCT Filed: Jun. 23, 2014
(86) PCT No.: PCT/GB2014/051915

§ 371 Date: Dec. 22, 2015

(30) Foreign Application Priority Data
Jun. 24, 2013 (GB) 1311160.4

(51) Int. Cl. G11B 27/10; G11B 27/28

(52) U.S. Cl. CPC G11B 27/102; G11B 27/28

(57) ABSTRACT

A system for controlling the presentation of audio-video programmes has an input for receiving audio-video programmes. A data comparison unit is arranged to produce at intervals throughout the programme a value for each of f features of the audio-video and then to derive from the features a metadata value, the metadata value having M dimensions, the number of dimensions being smaller than the number of features. A threshold is applied to the metadata value to determine points of interest within the audio-video programmes and a controller is arranged to control retrieval and playback of the programmes using the interesting points.

### BACKGROUND OF THE INVENTION

This invention relates to a system and method for controlling output of audio-video programmes.

Audio-video content, such as television programmes, comprises video frames and an accompanying sound track which may be stored in any of a wide variety of coding formats, such as MPEG-2 or MPEG-4. The audio and video data may be multiplexed and stored together or stored separately. In either case, a programme comprises such audio video content as defined by the programme maker. Programmes include television programmes, films, news bulletins and other such audio video content that may be stored and broadcast as part of a television schedule.

### SUMMARY OF THE INVENTION

We have appreciated the need to improve systems and methods by which programmes and portions of programmes may be retrieved, analysed and presented.

A system and method embodying the invention analyses an audio video programme at each of multiple intervals throughout the programme and produces a multidimensional continuous metadata value derived from the programme at each respective interval. The derivation of the complex continuous metadata value is from one or more features of the audio video programme at the respective intervals. The result is that the metadata value represents the nature of the programme at each time interval. The preferred type of metadata value is a mood vector that is correlated with the mood of the programme at the relevant interval.

An output is arranged to determine one or more interesting points within each programme by applying a threshold to the complex metadata values to find one or more intervals of the programme for which the metadata value is above the threshold. An interesting point is therefore one of the intervals for which the metadata value meets a criterion of being above a threshold. The threshold may be set such that the maximum metadata value is selected only (just one interesting point), may be fixed for the system (all metadata values above a single threshold for all programmes) or may be variable (so that a variable number of interesting points may be found for a given programme).

The output is provided to a controller arranged to control the retrieval and playback of the programmes using the interesting points. The controller may control the retrieval and output in various ways. One way is for the system to produce an automatic summary programme from each programme comprising only the content at the intervals found to have interesting points. The user may select the overall length of the output summary or the length of the individual parts of the output to enable appropriate review. This is useful for a large archive system allowing an archivist to rapidly review stored archives. Another way is to select only programmes having a certain number of interesting points. This is useful for a general user wishing to find programmes having a certain likely interest to that user.

### BRIEF DESCRIPTION OF THE DRAWINGS

The invention will now be described in more detail by way of example with reference to the drawings, in which:

FIG. 1: is a diagram of the main functional components of a system embodying the invention;

FIG. 2: is a diagram the processing module of FIG. 1;

FIG. 3: shows a time line mood value for a first example programme; and

FIG. 4: shows a time line mood value for a second example programme.

### DETAILED DESCRIPTION OF THE PREFERRED EMBODIMENTS

The invention may be embodied in a variety of methods and systems for controlling the output of audio video programmes. The main embodiment described is a controller for playback of recorded programmes such as a set top box, but other embodiments include both larger scale machines for retrieval and display of television programme archives containing thousands of programmes and smaller scale implementations such as personal audio video players, smart phones, tablets and other such devices.

The embodying system retrieves audio video programmes, processes the programmes to produce metadata values or vectors, referred to as mood vectors, at intervals throughout the programme and provides a controller by which programmes may then be selected and displayed. For convenience of description, the system will be described in terms of these three modules: retrieval, processing and controller.

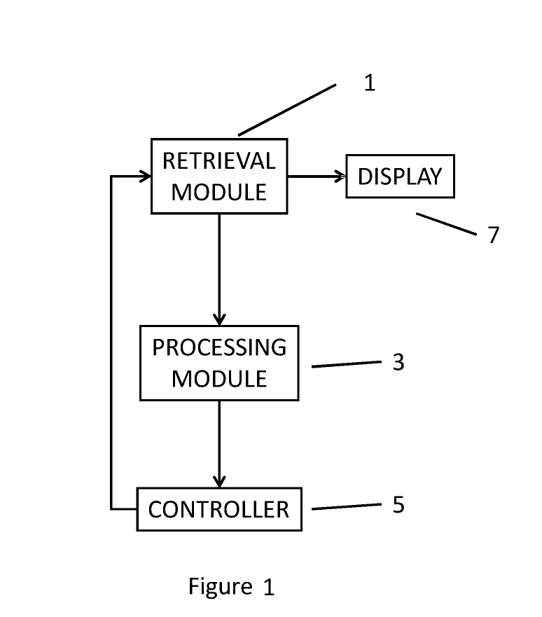

A system embodying the invention is shown in FIG. 1. A retrieval module 1 is arranged to retrieve audio video programmes which may be stored externally, or within the system and provide these to a processing module 3. The processing module 3 is arranged to process the audio video data of the programme to produce a vector at intervals that represents the “mood” of the programme for that interval. Optionally, the processing module may process other data associated with the programme, for example subtitles, to produce the mood vectors at intervals. The controller 5 receives the vectors for the programme and uses these as part of selection routines by which parts of the programmes may be selected and asserted to a display 7.

The intervals for which the processing is performed may be variable or fixed time intervals, such as every minute or every few minutes, or may be intervals defined in relation to the programme content, such as based on video shot changes or other indicators that are stored or derived from the programme. The intervals are thus useful sub-divisions of the whole programme.

### Metadata Production

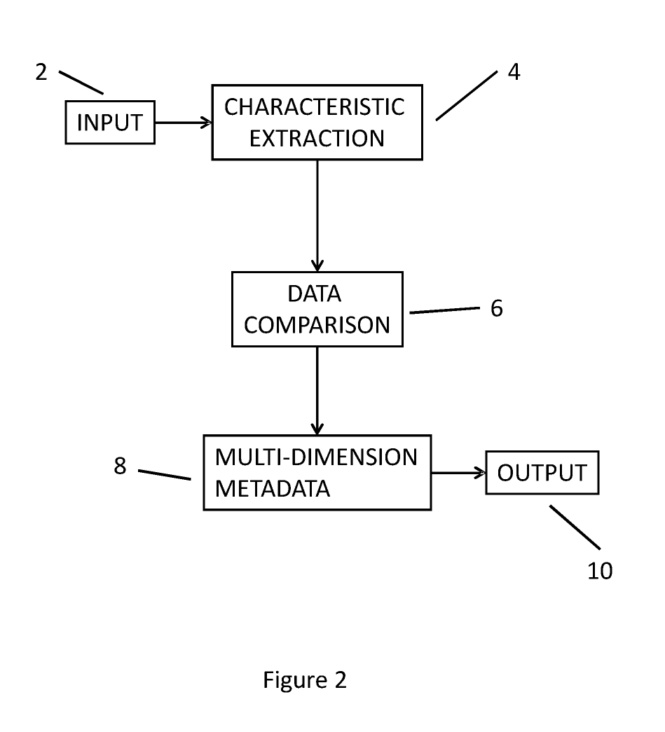

The production of the metadata referred to as mood vectors by the processing module 3 will now be described with reference to FIG. 2. The system comprises an input 2 for receiving the AV content, for example, retrieved from an archive database. A characteristics extraction engine 4 analyses the audio and/or video data to produce values for a number of different characteristics, such as audio frequency, audio spectrum, video shot changes, video luminance values and so on. A data comparison unit 6 receives the multiple characteristics for the content and compares the multiple characteristics to characteristics of other known content to produce a value for each characteristic. Such characteristic values, having been produced by comparison to known AV data, can thereby represent features such as the probability of laughter, relative rate of shot changes (high or low) existence and size of faces directed towards the camera. A multi-dimensional metadata engine 8 then receives the multiple feature values and reduces these feature values to a complex metadata value of M dimensions which may be referred to as a mood vector.

The extracted features may represent aspects such as laughter, gun shots, explosions, car tyre screeching, speech rates, motion, cuts, faces, luminance and cognitive features. The data comparison and multi-dimensional metadata units generate a complex metadata “mood” value from the extracted features. The complex mood value has humorous, serious, fast paced and slow paced components. The audio features include laughter, gun shots, explosions, car tyre screeching and speech rates. The video features include motion, cuts, luminance, faces and cognitive values.

The characteristic extraction engine 4 provides a process by which the audio data and video data may be analysed and characteristics discussed above extracted. For audio data, the data itself is typically time coded and may be analysed at a defined sampling rate discussed later. The video data is typically frame by frame data and so may be analysed frame by frame, as groups of frames or by sampling frames at intervals. Various characteristics that may be used to generate the mood vectors are described later.

The process described so far takes characteristics of audio-video content and produces values for features, as discussed. The feature values produced by the process described above relate to samples of the AV content, such as individual frames. In the case of audio analysis, multiple characteristics are combined together to give a value for features such as laughter. In the case of video data, characteristics such as motion maybe directly assessed to produce a motion feature value. In both cases, the feature values need to be combined to provide a more readily understandable representation of the metadata in the form of a complex metadata value. The metadata value is complex in the sense that it may be represented in M dimensions. A variety of such complex values are possible representing different attributes of the AV content, but the preferred example is a so-called “mood” value indicating how a viewer would perceive the features within the AV content. The main example mood vector that will be discussed has two dimensions: fast/slow and humorous/serious.

To produce the time interval mood vectors, the metadata engine 8 operates a machine learning system. The ground truth data may be from user trials where members of the general-public manually tag 3 minute clips of archive and current programmes in terms of content mood, or from user trials in which the members tag the whole programme with a single mood tag. The users tag programmes in each mood dimension to be used such as ‘activity’ (exciting/relaxing) generating one mood tag representing the mood of the complete programme (called whole programme user tag). The whole programme user tag and the programmes' audio/video features are used to train a mood classifier. The preferred machine learning method is Support Vector Machine (SVM) regression. Whilst the whole programme tagged classifier is used in the preferred embodiment for the time-line mood classification, other sources of ground truth could be used to train the machine learning system.

Having trained the Support Vector Machine, the metadata engine 8 may produce mood values at intervals throughout the duration of the programme. As examples, the time intervals evaluated are consecutive non-overlapping windows of 1 minute, 30 seconds and 15 seconds. The mood vector for a given interval is calculated from the features present during that time interval. This will be referred to as variable time-line mood classification.

The choice of time interval can affect how the system may be used. For the purpose of identifying moods of particular parts of a programme, a short time interval allows accurate selection of small portions of a programme. For improved accuracy, a longer time period is beneficial. The choice of a fixed time interval around one minute gives a benefit as this is short in comparison to the length of most programmes, but long enough to provide accuracy of deriving the mood vector for each interval.

### Output Control

Various ways in which the time line mood vectors may be asserted, by the output 10, and used by the controller 5, will now be described with reference to example audio video programmes.

A first example is to analyse extreme mood values. Extreme mood values are the maximum mood values with a high level of confidence. For example, extreme mood values that are generated from the 1 minute interval variable time-line mood classification method are assumed to be “interesting points” within the programme. The manner in which the mood values are calculated using machine learning results in values such that the level of confidence forms part of the value. Accordingly, high values by definition also have a high level of confidence.

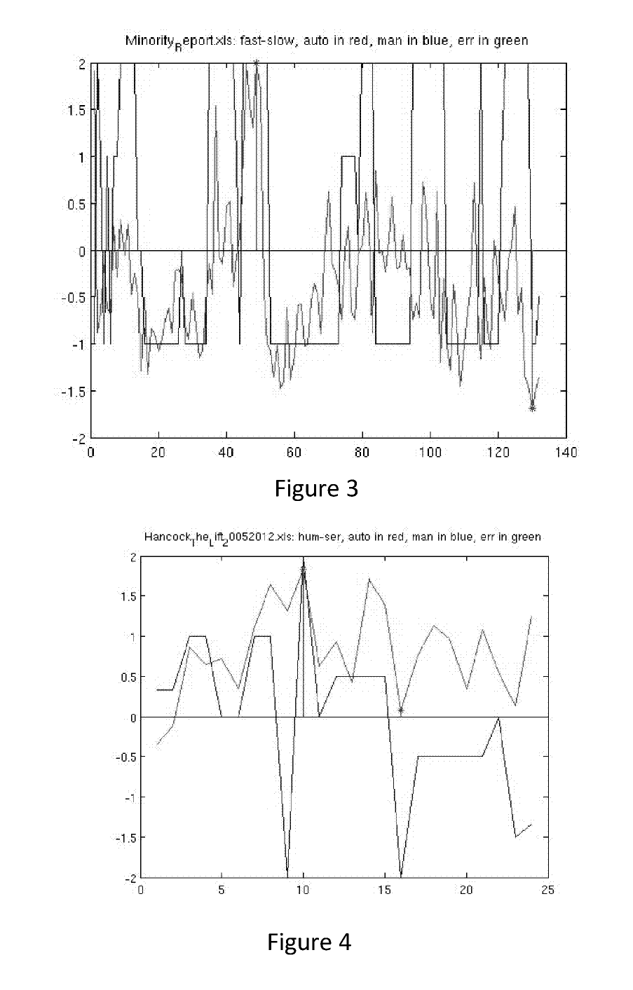

The time-line fast-paced/slow-paced mood classification for an example programme ‘Minority Report’ is shown in FIG. 3, in which the maximum mood value is at x=49 marked by the upper asterisk. The time-line humorous/serious mood classification for another example programme for humorous mood is ‘Hancock’ and has a maximum at x=10 shown below in FIG. 4 marked by the upper asterisk. The same process may be repeated for any number of different moods for a given programme and for multiple programmes.

A second example way in which the time line mood vectors may be used is to extract all mood values that are above a threshold. In doing so, multiple “interesting points” may be produced for a given programme. The threshold may be a fixed system wide threshold for each mood value, a variable for the system, or even for each programme. A programme with a number of peaks in mood value may, for example, have a higher threshold than one with fewer peaks so as to be more selective. The threshold may be user selectable or system derived.

Having determined one or more such “interesting points” for a given programme, a summary programme may be created using clips of one minute at the interesting points, for example. The summary programmes for the programme examples above would be as follows. The ‘Hancock’ summary consists of a humorous mood clip (Hancock arguing with lift attendant, audience laughter). The ‘Minority Report’ summary consists of a fast mood clip (Tom Cruise crashes into building, then a chase) and a clip that has both a slow mood and a serious mood (voice over and couple standing quietly). This technique can be used to automatically browse vast archives to identify programmes for re-use and therefore cut down the number of programmes that need to be viewed. The ‘interesting bits’ also provide a new format or preview service for audiences.

The length of the clips or summary sections may also be a variable of the system, preferably user selectable, so that summaries of various lengths may be selected. The clips could be the same length as the intervals from which the mood vectors were derived. Alternatively, the clip length may be unrelated to the interval length, for example allowing a user to select a variable amount of programme clip either side of one of the interval points.

### Characteristic Conversion

One way in which characteristics may be used to generate the mood vectors is now described for completeness.

The audio features will now be described followed by the video features.

### Audio

The low level audio features or characteristics that are identified include formant frequencies, power spectral density, bark filtered root mean square amplitudes, spectral centroid and short time frequency estimation. These low level characteristics may then be compared to known data to produce a value for each feature.

### Formant Frequencies.

These frequencies are the fundamental frequencies that make up human vocalisation. As laughter is produced by activation of the human vocal tract, formants frequencies are a key factor in this. A discussion of formant frequencies in laughter may be found in Szameitat et al “Interdisciplinary Workshop on the Phonetics of Laughter”, Saarbrucken, 4-5 Aug. 2007 found the F1 frequencies to be much higher than for normal speech patterns. Thus, they are a key feature for identification. Formant frequencies were estimated by using Linear Prediction Coefficients. In this, the first 5 formants were used. Experimental evidence showed that this gave the best results and study of further formants was superfluous. These first five formants were used as feature vectors. If the algorithm could not estimate five fundamental frequencies, then this window was given a special value indicating no match.

### Power Spectral Density

This is a measure of amplitude for different component frequencies. For this, Welch's Method (a known approach to estimate power vs frequency) was used for estimating the signals power as a function of frequency. This gave a power spectrum, from which the mean, standard deviation and auto covariance were calculated.

### Bark Filtered Root Mean Squared Amplitudes

As a follow on from looking at the power\amplitude in the whole signal using Welch's Method based on work contained in Welch, P. “The Use of Fast Fourier Transforms for the Estimation of Power Spectra: A Method Based on time Averaging over Short Modified periodgrams”, IEEE Transactions of Audio and Electroacoustics. Vol 15, pp 70-73 (Welch 1967), the incoming signal was put through a Bark Scale Filter bank. This filtering corresponds to the critical bands of human hearing of the human ear, following Bark Scales. Once the signal was filtered into 24 bands, the Root Mean Squared amplitudes were calculated for each filter bank, and used as a feature vector.

### Spectral Centroid.

The spectral centroid is used to determine where the dominant centre of the frequency spectrum is. A Fourier Transform of the signal is taken, and the amplitudes of the component frequencies are used to calculate the weighted mean. This weighted mean, along with the standard deviation and auto covariance were used as three feature values.

### Short Time Frequency Estimation.

Each windowed sample is split into a sub window each 2048 samples in length. From this autocorrelation was used to estimate the main frequency of this sub-window. The average frequency of all these sub-windows, the standard deviation and auto covariance were used as the feature vectors.

The low level features or characteristics described above give certain information about the audio-video content, but in themselves are difficult to interpret, either by subsequent processes or by a video representation. Accordingly, the low level features or characteristics are combined by data comparison as will now be described.

A low level feature, such as formant frequencies, in itself may not provide a sufficiently accurate indication of the presence of a given feature, such as laughter, gun shots, tyre screeches and so on. However, by combining multiple low level features/characteristics and comparing such characteristics against known data, the likely presence of features within the audio content may be determined. The main example is laughter estimation.

### Laughter Estimation

A laughter value is produced from low level audio characteristics in the data comparison engine. The audio window length in samples is half the sampling frequency. Thus, if the sampling frequency is 44.1 kHz, the window will be 22.05 k samples long, or 50 ms. There was a 0.2 sampling frequency overlap between windows. Once the characteristics are calculated, they are compared to known data (training data) using a variance on N-Dimensional Euclidean Distance. From the above characteristics extraction, the following characteristics are extracted;

| Formant Frequencies | Formants 1-5 |
|---|---|
| Power Spectral Density | Mean |
| | Standard Deviation |
| | Auto covariance |
| Bark Filtered RMS Amplitudes | RMS amplitudes for Bark |
| | filter bands 1-23 |
| Spectral Centroid | Mean |
| | Standard Deviation |
| | Auto covariance |
| Short Time Frequency Estimation | Mean |
| | Standard Deviation |
| | Auto covariance |

These 37 characteristics are then loaded into a 37 dimension characteristics space, and their distances calculated using Euclidean distance as follows;

$$d ( p , q ) = \sqrt{{\sum }_{i = 1}^{n} {( {p}_{i} - {q}_{i} )}^{2}}$$

This process gives the individual laughter content estimation for each windowed sample. However, in order to improve the accuracy of the system, adjacent samples are also used in the calculation. In the temporal domain, studio laughter has a definable temporal structure, the initial build up, full blown laughter followed by a trailing away of the sound.

From an analysis of studio laughter from a Sound effect library and laughter from 240 hours of AV material, it was found that the average length of the full blown laughter, excluding the build up and trailing away of the sound was around 50 ms. Thus, three windows (covering 90 ms being 50 ms in length each with a 20 ms offset) can then be used to calculate the probability p(L) of laughter in window i based upon each windows Euclidean distance from the training data d;

[symbol]

pLL [symbol] ᵢ)= [symbol] d(p [symbol] ᵢ₋₁, qᵢ₋₁)+ [symbol] d(p [symbol] ᵢ, qᵢ)+ [symbol] d(p [symbol] ᵢ₊₁, q+1)

where

d(pᵢ₋₁, qᵢ₋₁)>d(pᵢ,qᵢ)<d(pᵢ₊₁, qᵢ₊₁) and d(pᵢ,qᵢ)<threshold

Once the probability of laughter is identified, a feature value can be calculated using the temporal dispersal of these identified laughter clips. Even if a sample were found to have a large probability of containing laughter, if it were an isolated incident, then the programme as a whole would be unlikely to be considered as “happy”. Thus, the final probability p(L) is upon the distance d of window i;

$${dt}_{i} = ( T ( p ( {L}_{i} ) ) - T ( p ( {L}_{i - 1} ) ) ) + ( T ( p ( {L}_{i + 1} ) - T ( p ( {L}_{i} ) ) ) \\ p ( {L}_{i} ) = \frac{1}{{e}^{{dt}_{i}}}$$

To assess the algorithms described when the probability of laughter reaches a threshold of 80%, a laughter event was announced and, for checking, this was displayed as an overlaid subtitle on the video file.

### Other Audio Features

Gun shots, explosions and car tyre screeches are all calculated in the same way, although without the use of formant frequencies. Speech rates are calculated using Mel Frequency Cepstrum Coeffecients and formant frequencies to determine how fast people are speaking on screen. This is then used to ascertain the emotional context with which the words are being spoken. If words are being spoken in rapid succession with greater energy, there is more emotional intensity in the scene than if they are spoken at a lower rate with lower energy.

### Video

The video features may be directly determined from certain characteristics that are identified are as follows.

### Motion

Motion values are calculated from 32×32 pixel gray scaled version of the AV content. Motion value is produced from the mean difference between the current frame fₖ and the tenth previous frame fₖ₋₁₀.

The motion value is:

Motion=scale*Σ|fₖ−fₖ₋₁₀′

### Cuts

Cuts values are calculated from 32×32 pixel gray scaled version of the AV content. Cuts value is produced from the threshold product of the mean difference and the inverse of the phase correlation between the current frame fₖ and previous frame fₖ₋₁.

The mean difference is:

md=scale*Σ|fk−fk₁^{|}

The phase correlation is:

pc=max(invDFT((DFT(fₖ)*(DFT(_{fk-1})′))/|(DFT(fₖ)*(DFT(fₖ₋₁)′)|)))

The cuts value is:

Cuts=threshold(md*(1−pc))

### Luminance

Luminance values are calculated from 32×32 pixel gray scaled version of the AV content. Luminance value is the summation of the gray scale values:

Luminance=Σfₖ

Change in lighting is the summation of the difference in luminance values. Constant lighting is the number of luminance histogram bins that are above a threshold.

### Face

Face value is the number of full frontal faces and the proportion of the frame covered by faces for each frame. Face detection on the gray scale image of each frame is implemented using a mex implementation of OpenCV's face detector from Matlab central. The code implements Viola-Jones adaboosted algorithm for face detection.

### Cognitive

Cognitive features are the output of simulated simple cells and complex cells in the initial feed forward stage of object recognition in the visual cortex. Cognitive features are generated by the ‘FH’ package of the Cortical Network Simulator from Centre for Biological and Computational Learning, MIT.

As previously described the invention may be implemented in systems or methods, but may also be implemented in program code executable on a device, such as a set top box, or on an archive system or on a personal device.

1. A system for controlling the presentation of audio-video programmes, comprising:
an input for receiving audio-video programmes;
a data comparison unit arranged to produce, for each programme, a value for each of f features of the audio video programme at intervals throughout the programme derived from the programme at the corresponding interval;
a multi-dimensional metadata unit arranged to receive the values for each feature and to produce a complex continuous metadata value of M dimensions, at each interval, for each programme where M<f;
an output arranged to determine one or more interesting points within each programme by applying a threshold to the complex metadata values to find one or more intervals of the programme for which the metadata value is above the threshold; and
a controller arranged to control the retrieval and playback of the programmes using the interesting points.

2. A system according to claim 1, wherein the threshold is variable such that a single interesting point is produced for each programme, being for the interval having the maximum metadata value for the programme.

3. A system according to claim 1, wherein the threshold is variable such that multiple interesting points are produced for each programme.

4. A system according to claim 1, wherein the controller is arranged playback a summary of each programme by playing a portion at each of the one or more interesting points.

5. A system according to claim 4, wherein the controller is arranged to receive a user selection of the length of each portion and to playback a summary comprising portion of that length.

6. A system according to claim 4, wherein the controller is arranged to receive a user selection of the length of the summary and to playback a summary of that length.

7. A system according to claim 1, wherein the controller is arranged to playback in order of programmes having the most interesting points.

8. A system according to claim 1, wherein the controller is arranged to receive a user selection of mood values and to arrange playback of portions of programmes having interesting points matching those mood values.

9. A system according to claim 1, wherein the interval is variable based on user selection.

10. A system according to claim 1, wherein the interval is variable based on system derived analysis.

11. A system according to claim 1, further comprising a characteristic extraction unit arranged to extract n multiple distinct characteristics from the received audio-video data, and wherein the data comparison unit is arranged to compare the n multiple distinct characteristics with data extracted from example audio-video data by comparing in n dimensional space to produce a value for each off features of the audio-video data where f<n.

12. A method for controlling the presentation of audio-video programmes, comprising:
receiving audio-video programmes;
producing, for each programme, a value for each of f features of the audio video programme at intervals throughout the programme derived from the programme at the corresponding interval;
receiving the values for each feature and producing a complex continuous metadata value of M dimensions, at each interval, for each programme where M<f;
determining one or more interesting points within each programme by applying a threshold to the complex metadata values to find one or more intervals of the programme for which the metadata value is above the threshold; and
controlling the retrieval and playback of the programmes using the interesting points.

13. A method according to claim 12, wherein the threshold is variable such that a single interesting point is produced for each programme, being for the interval having the maximum metadata value for the programme.

14. A method according to claim 12, wherein the threshold is variable such that multiple interesting points are produced for each programme.

15. A method according to claim 12, comprising automatically playing a portion at each of the one or more interesting points.

16. A method according to claim 15, comprising receiving a user selection of the length of each portion and playing a portion of that length.

17. A method according to claim 15, comprising receiving a user selection of the length of the summary and playing a summary of that length.

18. A method according to claim 12, comprising automatically arranging playback in order of programmes having the most interesting points.

19. A method according to claim 12, comprising receiving a user selection of mood values and automatically arranging playback of portions of programmes having interesting points matching those mood values.

20. A method according to claim 12, wherein the interval is variable based on user selection.

21. A method according to claim 12, wherein the interval is variable based on system derived analysis.

22. A method according to claim 12, further comprising extracting n multiple distinct characteristics from the received audio-video data, and comparing the n multiple distinct characteristics with data extracted from example audio-video data by comparing in n dimensional space to produce a value for each off features of the audio-video data where f<n.

23. A computer program comprising code which when executed undertakes the method of claim 12.
